(19) United States
(12) Patent Application Publication
(10) Pub. No.: US 2007/0233901 A1
(43) Pub. Date: Oct. 4, 2007

(54) METHODS AND SYSTEMS FOR INTEGRATING NETWORK SERVICES WITH MULTIPLE COMMUNICATION PROTOCOLS

(76) Inventors: Stephen KUAN, Auckland (NZ); Sheng-Hsin KANG, Taipei (TW); Neng-Yu TU, Sindian (TW)

Correspondence Address: MORRIS MANNING MARTIN LLP, 3343 PEACHTREE ROAD, NE, 1600 ATLANTA FINANCIAL CENTER, ATLANTA, GA, 30326, US

(21) Appl. No.: 11/308,537

(22) Filed: Apr. 4, 2006

(51) Int. Cl. G06F 15/16

(52) U.S. Cl. 709/246; 709/230

(57) ABSTRACT

The methods and systems for interconnecting communications in different communication protocols, comprising: (i) an internal interface having at least one client using at least one of a first group of communication protocol, for communicating with a user, (ii) an external interface having at least one client using at least one of a second group of communication protocol, for communicating with at least one recipient, and (iii) a Messenger/VoIP Router System (MVRS) for interconnecting communication between the user and the at least one recipient, wherein, in operation, the user initiates or receives a communication using at least one of the first group of communication protocols, and the MVRS interconnects the communication to or from the at least one recipient using at least one of the second group of communication protocols according to a set of interconnecting rules maintained in the MVRS.

### FIELD OF THE PRESENT INVENTION

The present invention relates to methods and systems for integrating network services with multiple communication protocols. More particularly, the present invention relates to a Messenger/Voice Over IP (VoIP) Router System (hereinafter “MVRS”) for offering interconnection among VoIP such as Session Initiation Protocol (hereinafter “SIP”) protocol, Skype® service and other available communication protocols.

### BACKGROUND OF THE PRESENT INVENTION

The landscape of telecommunication networks has been greatly changed due to the rapid growth and increased uses of the Internet. Traditionally, people depend on the fixed landline to make a call cross a street, cross a country, or over the world. With the rapid growth and development of the Internet, many alternative resources become available to connect people in addition to the traditional landline telephone system. People can exchange text messages, voice messages or video messages over the Internet such as MSN® instant message (hereinafter “IM”), or Yahoo® IM. VoIP telephony is becoming more reliable and is accepted by millions users of the Internet. There are many different implementations of VoIP telephony technology. Two predominant VoIP telephony networks are SIP and Skype®.

Session Initiation Protocol

The Session Initiation Protocol or SIP, is a protocol developed by IETF Multiparty Multimedia Session Control Working Group and proposed standard for initiating, modifying, and terminating an interactive user session that involves multimedia elements such as video, voice, instant messaging, online games, and virtual reality. In November 2000, SIP was accepted as a 3rd Generation Partnership Project (3GPP) signaling protocol and permanent element of the IMS architecture. It is one of the leading signaling protocols for Voice over IP.

SIP provides the necessary protocol mechanisms so that end systems and proxy servers can provide services:
various call forwarding services;
called party and calling “number” delivery, where numbers can be any (preferably unique) naming scheme;
personal mobility, i.e., the ability to reach a called party under a single, location-independent address even when the user changes terminals;
terminal-type negotiation and selection: a caller is given a choice how to reach the party, e.g., via Internet telephony, mobile device, an answering service, etc.;
terminal capability negotiation;
caller and callee authentication;
blind and supervised call transfer; and
invitations to multicast conferences.

Extensions of SIP to allow third-party signaling (e.g., for click-to-dial services, fully meshed conferences and connections to multipoint control units (MCUs), as well as mixed modes and the transition between those) are available.

SIP addresses users by an email-like address and re-uses some of the infrastructure of electronic mail delivery such as DNS MX records or using SMTP for address expansion. SIP addresses (URLs) can also be embedded in web pages. SIP is addressing-neutral, with addresses expressed as URLs of various types such as SIP, H.323 or telephone (E.164).

SIP can also be used for signaling Internet real-time fax delivery. This requires no major changes. Fax might be carried via RTP, TCP or other mechanisms.

SIP is independent of the packet layer and only requires an unreliable datagram service, as it provides its own reliability mechanism. While SIP typically is used over UDP or TCP, it could, without technical changes, be run over carrier pigeons, frame relay, ATM, in rough order of desirability.

Skype®

Skype® is a proprietary peer-to-peer Internet telephony (VoIP) network, competing against established open VoIP protocols like SIP or H.323. The system has a reputation for working across different types of network connections including firewalls and network address translation (NAT) because voice packets are routed by the combined users of the free desktop software application. Skype® users can speak to other Skype® users, Skype® Chat, and Skype®) Video Calling for free. Skype® also offer fee-based services such as SkypeOut®, SkypeIn® and Skype® Voicemail. SkypeOut® allows a user to call traditional telephone numbers. SkypeIn® enables a user to receive calls from traditional phones. Skype® Voicemail allows a user to receive voicemail messages.

Each Skype® user must install the Skype® software on his/her computer and the software must be running while using any of the Skype® functionalities. This software is currently available free of charge and can be downloaded from the company website, but the software is proprietary.

The major difference between Skype® and SIP clients is that the Skype® operates on a peer-to-peer model rather than the more traditional server-client model. The Skype® user directory is entirely decentralized and distributed among the nodes in the network, which means the network can scale very easily to large sizes (currently just over forty million users) without a complex and costly centralized infrastructure.

Skype® also routes calls through other Skype® peers on the network, which allows it to traverse Symmetric NATs and firewalls, unlike SIP programs. This, however, puts an extra burden on those who connect to the Internet without NAT, as their computers and network bandwidth may be used to route the calls of other users. The selection of intermediary computers is fully automatic, with individual users having no option to disable such use of their resources.

The Skype® code is closed source and the protocol is proprietary. The Skype®) client's application programming interface (API) exposes the network to software developers. The Skype® API allows other programs to use the Skype® network to get “white pages” information and manage calls.

Since its debut, Skype®'s free software only worked on Microsoft devices, though test versions of the Linux and Macintosh software have been available since 2005. New renditions of Skype® software for Linux and Macintosh operating systems are available early 2006. The new releases are a significant expansion for 17-month-old Skype®. The number of new Skype® users is increasing at rates not seen since the early days of instant messaging, and at no cost to Skype® other than hosting a Web site to make the software available.

Other Protocols

In addition to the most popular two protocols described above, there are many other protocols available for users to communicate over the Internet or IP networks. These protocols include: H.323 protocol to provide audio-visual communication sessions on any packet network, Media Gateway Control Protocol (MGCP) used within a Voice over IP system, America On Line® (AOL®) instant messenger system, Google®® Talk, Yahoo® instant messenger (IM), MSN® Netmeeting and other proprietary or open control method or protocols. In most cases, these different protocols create their own communities that the members of each community communicate freely but not to other communities with different protocols. For example, both Yahoo® IM and MSN®) IM offer audio/visual messenger services. In order to communicate with members of both communities, a user needs to have two accounts, one for Yahoo®, and other for MSN®. There is a need to create a system that is portable, convenient, and that unites all these communication protocols so that a member of one community can communicate freely with all other communities.

Therefore, a heretofore unaddressed need exists in the art to address the aforementioned deficiencies and inadequacies.

### SUMMARY OF THE PRESENT INVENTION

In one aspect, the present invention relates a system for interconnecting communications in different communication protocols. The system comprises: (i) an internal interface having at least one client using at least one of a first group of communication protocols, for communicating with a user; (ii) an external interface having at least one client using at least one of a second group of communication protocols, for communicating with at least one recipient; and (iii) a Messenger/VoIP Router System (MVRS) for interconnecting communication between the user and the at least one recipient. The user initiates or receives a communication using at least one of the first group of communication protocols, and the MVRS interconnects the communication to or from the at least one recipient using at least one of the second group of communication protocols according to a set of interconnecting rules maintained in the MVRS.

In one embodiment, the MVRS comprises: (i) a connection control unit for controlling all call logic and system command function; (ii) a media stream router for interconnecting, converting and matching media streams of different protocols; (iii) a message router for interconnecting, converting messages of different protocols; and (iv) a routing table for determining the messenger message and media stream routing. In another embodiment, the MVRS comprises: (i) a connection control unit for controlling all call logic and system command function; (ii) a message router for interconnecting, converting messages of different protocols; and (iii) a routing table for determining the messenger message and media stream routing. In yet another embodiment, the MVRS comprises: (i) a connection control unit for controlling all call logic and system command function; (ii) a media stream router for interconnecting, converting and matching media streams of different protocols; and (iii) a routing table for determining the messenger message and media stream routing.

In one embodiment, the first group of communication protocols comprise conventional telephone, Voice over IP (VoIP), Session Initiation Protocol (SIP), Media Gateway Control Protocol (MGCP), H.323, Skype®, Gabber®, American On Line®) (AOL®), instant messaging computer program (ICQ), Google® Talk, Yahoo®) Messenger, MSN® Messenger, and other proprietary and open control messengers protocols. In another embodiment, the second group of communication protocols comprise conventional telephone, Voice over IP (VoIP), Session Initiation Protocol (SIP), Media Gateway Control Protocol (MGCP), H.323, Skype®, Gabber®, American On Line® (AOL®), instant messaging computer program (ICQ), Google®) Talk, Yahoo® Messenger, MSN®) Messenger, and other proprietary and open control messengers protocols. The communication between the user and the at least one recipient comprise conventional telephone calls, VoIP calls, video conference calls, multi-media instant messenger sessions, online games, and virtual realities, among two or more people.

In one embodiment, the system is software stored in a non-volatile storage device. The non-volatile storage device comprises compact flash memory, secure digital memory (SD), mini SD, micro SD, memory stick, memory stick Duo, floppy disk, CD R/W, DVD R/W and other readable and writable, or read-only memory device. In another embodiment, the non-volatile storage device further stores at least one of contact information, interconnection rules, configuration data, authentication/authorization information and communication log and historical data. The authentication/authorization information stored in the non-volatile storage device enables the user to communicate with the at least one recipient securely and prevents unauthorized uses.

In one embodiment, the non-volatile storage device is accessible by a computer, a portable phone, or a mobile device. In another embodiment, the computer, the portable phone, or the mobile device is connected to the Internet. In yet another embodiment, the software is accessible through available USB ports, memory card slots, CD/DVD readers, floppy drives of the computer, the portable phone, or the mobile device.

In another aspect, the present invention relates to a method for interconnecting communications in different communication protocols. The method comprises the steps of: (i) installing software on a computer, a portable phone or a mobile device, (ii) setting up contact information, (iii) setting up interconnection rules, (iv) waiting for a incoming communication from supported networks, (v) routing the incoming communication to destination with the same or different communication protocol according to the interconnection rules stored in the routing table to establish a communication, (vi) terminating the communication, and (vii) repeating steps (iv) through step (vi) until the computer, the portable phone, or the mobile device is instructed to terminate or is switched off. The software comprises: (a) an internal interface having at least one client using at least one of a first group of communication protocol, for communicating with a user, (b) an external interface having at least one client using at least one of a second group of communication protocol, for communicating with at least one recipient, and (c) a Messenger/VoIP Router System (MVRS) for interconnecting communication between the user and the at least one recipient. In one embodiment, the computer, the portable phone, or the mobile device is connected to the Internet.

In one embodiment, the first group of communication protocols comprise conventional telephone, voice over IP (VoIP), Session Initiation Protocol (SIP), Media Gateway Control Protocol (MGCP), H.323, Skype®, Gabber®, American On Line® (AOL®), instant messaging computer program (ICQ), Google® Talk, Yahoo® Messenger, MSN® Messenger, and other proprietary messengers and open control protocols. In another embodiment, the second group of communication protocols comprise conventional telephone, voice over IP (VoIP), Session Initiation Protocol (SIP), Media Gateway Control Protocol (MGCP), H.323, Skype®, Gabber®, American On Line® (AOL®), instant messaging computer program (ICQ), Google® Talk, Yahoo® Messenger, MSN® Messenger, and other proprietary messengers and open control protocols. The communications comprise a conventional telephone call, a VoIP call, a video conference call, instant message session, a multi-media instant messenger session, among two or more people.

In one embodiment, the MVRS comprises: (i) a connection control unit for controlling all call logic and system command function, (ii) a media stream router for interconnecting, converting and matching media streams of different protocols, (iii) a message router for interconnecting, converting messages of different protocols, and (iv) a routing table for determining the messenger message and media stream routing. In another embodiment, the MVRS comprises: (i) a connection control unit for controlling all call logic and system command function, (ii) a message router for interconnecting, converting messages of different protocols, and (iii) a routing table for determining the messenger message and media stream routing. In yet another embodiment, the MVRS comprises: (i) a connection control unit for controlling all call logic and system command function, (ii) a media stream router for interconnecting, converting and matching media streams of different protocols, and (iii) a routing table for determining the messenger message and media stream routing.

In one embodiment, the installing software step comprises the step of extracting the software from a non-volatile storage device. The non-volatile storage device comprises compact flash memory, secure digital memory (SD), mini SD, micro SD, memory stick, memory stick Duo, floppy disk, CD R/W, DVD R/W and other readable, writable or read-only memory card. In one embodiment, the non-volatile storage device stores contact information, interconnection rules, configuration data, authentication/authorization information and communication log and historical data. In another embodiment, the step of setting up contact information comprises the step of extracting contact information from the non-volatile storage device. In yet another embodiment, the step of setting up interconnection rules comprises the step of extracting interconnection rules from the non-volatile storage device.

In yet another aspect the present invention relates to a computer-readable medium having computer executable instructions for interconnecting communications in different communication protocols. In one embodiment, the computer-readable medium having computer executable instructions comprises: (i) an internal interface having at least one client using at least one of a first group of communication protocol, for communicating with a user, (ii) an external interface having at least one client using at least one of a second group of communication protocol, for communicating with at least one recipient, and (iii) a Messenger/VoIP Router System (MVRS) for interconnecting communication between the user and the at least one recipient. The user initiates or receives a communication using at least one of the first group of communication protocols, and the MVRS interconnects the communication to or from the at least one recipient using at least one of the second group of communication protocols according to a set of interconnecting rules maintained in the MVRS.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

Further features and benefits of the present invention will be apparent from a detailed description of preferred embodiments thereof taken in conjunction with the following drawings, wherein similar elements are referred to with similar reference numbers, and wherein:

FIG. 1 shows an overview of a Messenger/VoIP Router System according to one embodiment of the present invention.

FIG. 2 is a block diagram showing how a Messenger/VoIP Router System interacts with other clients with different protocols according to one embodiment of the present invention.

FIG. 3 shows a Messenger/VoIP Router System encased in a personal storage device according to one embodiment of the present invention.

FIG. 4 shows an exemplary embodiment of a personal storage device according to one embodiment of the present invention.

FIG. 5 is a flow chart showing the call connection operation of a Messenger/VoIP Router System according to one embodiment of the present invention.

FIG. 6 is a flow chart showing the connection process of a Messenger/VoIP Router System according to one embodiment of the present invention.

FIG. 7 illustrates how a SIP call is transferred to a Skype® call according to one embodiment of the present invention.

FIG. 8 illustrates how a Skype® call is transferred to a SIP call according to one embodiment of the present invention.

### DETAILED DESCRIPTION OF THE PRESENT INVENTION

Prior to a detailed description of the present invention(s), the following definitions are provided as an aid to understanding the subject matter and terminology of aspects of the present invention(s), and not necessarily limiting of the present invention(s), which are expressed in the claims. Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. A capitalized term within the glossary usually indicates that the capitalized term has a separate definition within the glossary. However, the capitalization or lack thereof within the remainder of this document is not intended to be necessarily limiting unless the context clearly indicates that such limitation is intended.

### DEFINITIONS/GLOSSARY

E.164: an ITU-T recommendation which defines the international public telecommunication numbering plan used in the Public Switched Telephone Network (PTSN) and some other data networks. It also defines the format of telephone numbers. E.164 numbers can have a maximum of 15 digits and are usually written with a +prefix.

Mobile devices: any devices used for communication over wireless communication networks, such as a cellular phone, a walkie-talkie, a personal digital assistant (PDA), a pager, a smart phone or any combinations thereof.

MMUSIC: Mutiparty Multimedia Session Control.

LANs: local-area networks, the computers are geographically close together (that is, in the same building).

Protocol: A protocol defines a common set of rules and signals that computers on the network use to communicate. One of the most popular protocols for LANs is called Ethernet. Another popular LAN protocol for PCs is the IBM token-ring network.

PSd: Personal Storage disc has USB and SD dual interface. It is a perfect data exchange solution between your PC and consumer electronics device.

PSTN: public switched telephone network is the concentration of the world's public circuit-switched telephone networks. The PSTN is now almost entirely digital, and now includes mobile as well as fixed telephones.

NAT: network address translation (also known as network masquerading or IP-masquerading) involves re-writing the source and/or destination addresses of IP packets as they pass through a router or firewall. Most systems using NAT do so in order to enable multiple hosts on a private network to access the Internet using a single public IP address.

DNS: Domain Name System.

MX: Mail eXchange record is a type of resource record in the Domain Name System specifying how Internet e-mail should be routed.

SMTP: Simple Mail Transfer Protocol is the de facto standard for e-mail transmission across the Internet.

VoIP: voice over IP.

SIP: is a protocol developed by the IETF MMUSIC Working Group and proposed standard for initiating, modifying, and terminating an interactive user session that involves multimedia elements such as video, voice, instant messaging, online games, and virtual reality.

MGCP: Media Gateway Control Protocol, a protocol used within a Voice over IP system.

Gabber®: a free software and open-source GNOME client for an instant messaging network called Jabber®.

AOL®: American On Line®, an online service provider, Internet service provider, and media company, offering AOL® Instant Messaging (IM) and many other services.

ICQ: instant messaging computer program.

URL: Uniform Resource Locator, or (less formally) Web address, is a sequence of characters for referring to resources, such as documents and images on the Internet, by their location.

H.323: a recommendation from the ITU-T, defining protocols to provide audio-visual communication sessions on any packet network.

RTP: a standardized packet format for transmitting audio and video over the Internet.

UDP: User Datagram Protocol is one of the core protocols of the Internet protocol suite. Using UDP, programs on networked computers can send short messages known as datagrams to one another.

TCP: Transmission Control Protocol is one of the core protocols of the Internet protocol suite. Using TCP, applications on networked hosts can create connections to one another, over which they can exchange data or packets.

ATM: Asynchronous Transfer Mode, is a cell relay network protocol which encodes data traffic into small fixed-sized (53 byte; 48 bytes of data and 5 bytes of header information) cells instead of variable sized packets.

UI: User Interface. Typically means a software Application with which a User interacts for purposes of entering information, obtaining information, or causing functions of an associated system to execute.

System Overview

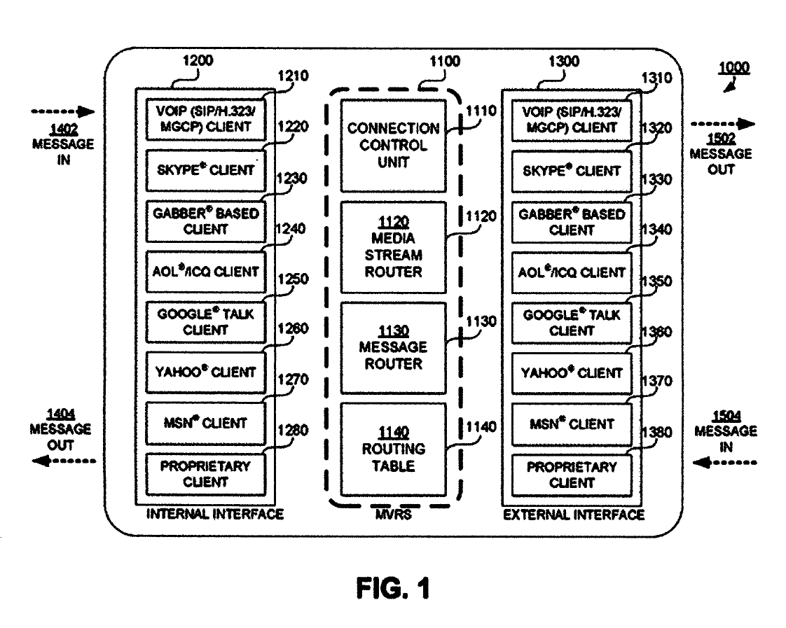

The present invention relates to a system for interconnecting communications in different communication protocols 1000. The system 1000 is presented in FIG. 1 according to one embodiment of the present invention. The system comprises: (i) an internal interface 1200 having a plurality of clients 1210-1280 in a first group of communication protocols for a communicating with a user through a message in 1402 and a message out 1404; (ii) an external interface having a plurality of clients 1310-1380 in a second group of communication protocols for a communicating with at least one recipient through a message in 1502 and a message out 1504; (iii) a Messenger/VoIP Router System (MVRS) 1100 for interconnecting communication between the user through the internal interface 1200 and the at least one recipient through the external interface 1300.

The internal client interfaces 1200 comprise: (a) a VoIP (SIP/H.323/MGCP) client interface 1210, (b) a Skype® client interface 1220, (c) a Gabber® based client interface 1230, (d) an AOL®/ICQ client interface 1240, (e) a Google® Talk client interface 1250, (f) a Yahoo® client interface 1260, (g) an MSN® client interface 1270, and (h) a proprietary client interface 1280. The internal interfaces 1200 are used to connect to a SIP based the communication device or a local IP network such as a LAN.

The external client interfaces 1300 comprise: (a) a VoIP (SIP/H.323/MGCP) client interface 1310, (b) a Skype® client interface 1320, (c) a Gabber® based client interface, (d) an AOL®/ICQ client interface 1340, (e) a Google® Talk client interface 1350, (f) a Yahoo® client interface 1360, (g) an MSN® client interface 1370, and (h) a proprietary client interface 1380. The external interfaces 1300 are used to connect to the Internet.

In one embodiment, the MVRS 1100 comprises: (i) a connection control unit 1110 for controlling all call logic and system command function; (ii) a media stream router 1120 for interconnecting, converting and matching media streams of different protocols; (iii) a message router 1130 for interconnecting, converting messages of different protocols; and (iv) a routing table 1140 for determining the messenger message and media stream routing. This embodiment is capable of communicating with conventional telephone calls, VoIP calls, video conference calls, text messenger sessions, multi-media instant messenger sessions, online games, and virtual realities, among two or more people.

In another embodiment, the MVRS 1100 comprises: (i) a connection control unit 1110 for controlling all call logic and system command function; (ii) a message router 1130 for interconnecting, converting messages of different protocols; and (iii) a routing table 1140 for determining the messenger message and media stream routing. This embodiment is capable of communicating with conventional telephone calls, VoIP calls, text messenger sessions, among two or more people.

In yet another embodiment, the MVRS 1100 comprises: (i) a connection control unit 1110 for controlling all call logic and system command function; (ii) a media stream router 1120 for interconnecting, converting and matching media streams of different protocols; (iii) a routing table 1140 for determining the messenger message and media stream routing. This embodiment is capable of communicating with conventional telephone calls, VoIP calls, video conference calls, multi-media instant messenger sessions, online games, and virtual realities, among two or more people.

A user or a user agent supported by the MVRS 1100 is connected with the internal interface 1200 for any outgoing communication 1402 and 1502, and the external interfaces 1300 are connected to the Internet for any incoming communication 1504 and 1404. An outgoing communication 1402 from the user agent is received by the internal interfaces 1200 and the connection control unit 1110 detects the source, destination, the protocols of the source and the destination, controls the communication logic. The connection control unit 1110 then looks up from the routing table 1140 and decides how the communication is handled. If communication is a simple text or voice message, the communication is then handled by the message router 1130 by transferring the call/message to its appropriate output client, and converting the call/message from the source protocol to the destination protocol if required. Otherwise, if the communication is of multimedia type and both source and destination protocol are capable of handling such multimedia communication, then the communication is handled by the media stream router 1120 by interconnecting the source and the destination clients, matching or converting the message from the source protocol to the destination protocol if required. The appropriate client that matches the destination protocol of the external interfaces 1300 generates and transmits the output communication 1502 to the destination.

The communication in reverse direction works in a similar manner. An incoming communication 1504 from an external user is received by appropriate client of the external interface 1300 and the connection control unit 1110 detects the source, destination, the protocols of the source and the destination, controls the communication logic. The connection control unit 1110 then looks up from the routing table 1140 and decides how the communication is handled. If communication is a simple text or voice message, the call/message is then handled by the message router 1130 by transferring the call/message to its appropriate output client, and converting the message from the source protocol to the destination protocol if required. Otherwise, if the communication is of multimedia type and both source and destination protocol are capable of handling such multimedia communication, then the communication is handled by the media stream router by interconnecting the source and the destination clients, matching and/or converting the media streams of different protocols from the source protocol to the destination protocol if required. The appropriate client that matches the destination protocol of the internal interfaces 1200 generates and transmits the output communication 1502 to the destination.

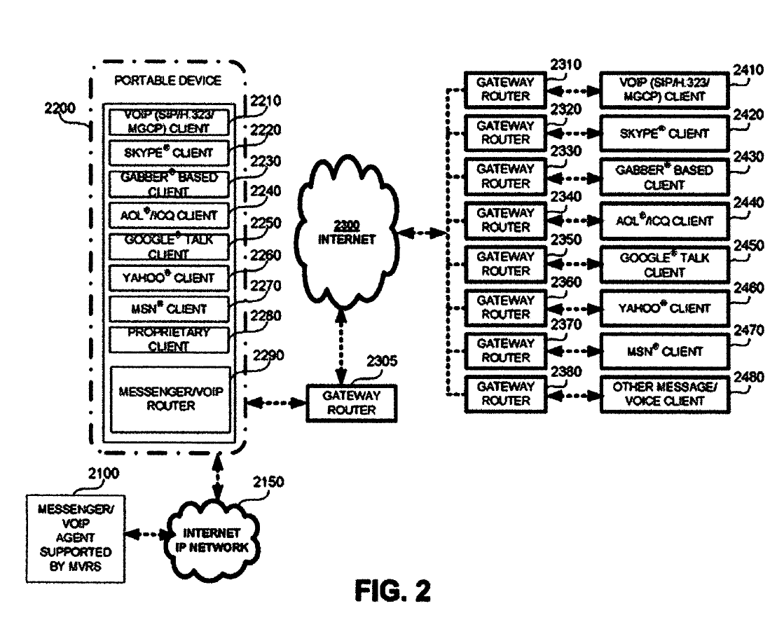

FIG. 2 is a block diagram showing how an MVRS interacts with other clients of different protocols according to one embodiment of the present invention. A Messenger/VoIP user agent 2100 supported by MVRS is connected through the Internet or a local area network (LAN) to a portable device 2200 a MVRS 2290 and a plurality of client interfaces 2210-2280. The portable device 2200 is then connected to the Internet 2300 through a gateway router 2305. A plurality of gateway routers 2310 through 2380 are connected in one side to the Internet 2300 and in the other side to a plurality of the client interfaces 2410 through 2480 of different protocols. The communication started from the user agent 2100 travels to the MRVS, an appropriate client interface, the Gateway Router 2305, the Internet 2300, an appropriate Gateway Router matching the destination protocol, and an appropriate client interface of the destination. The communication in reverse direction works in a similar manner.

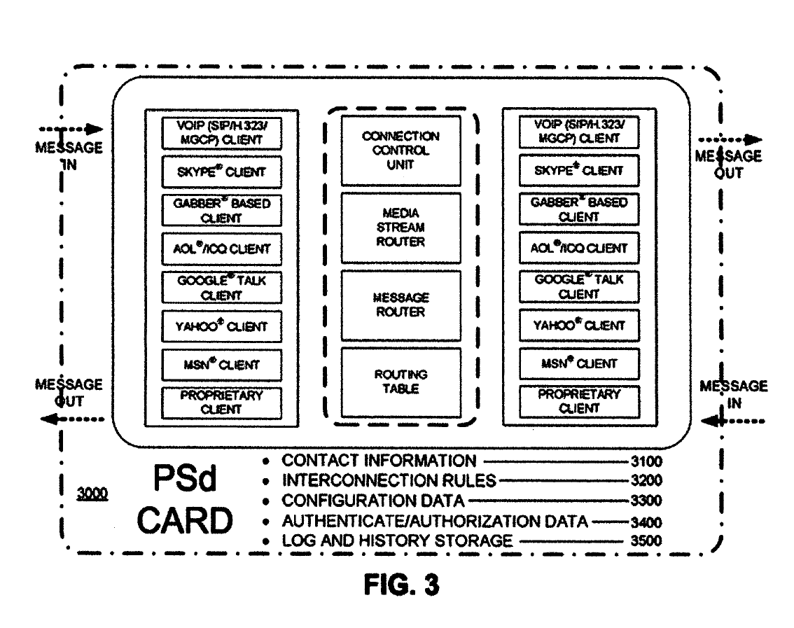

The Messenger/VoIP Router System is a software based solution. FIG. 3 shows a MVRS stored in a non-volatile storage device according to one embodiment of the present invention. In additional to the MVRS system, the non-volatile storage device also contains other information such as contact information 3100, interconnection rules 3200, configuration data 3300, authentication and/or authorization information 3400, communication log and historical data 3500. The contact information includes all the contact addresses, phone numbers, email addresses, Instant Messenger ID of authorized user (s) of the MVRS system. The interconnection rules and configuration data are created at the startup and maintained by the authorized user (s). All activities performed by the MVRS are tracked and logged into a communication log and any historical data is also saved in the non-volatile storage device.

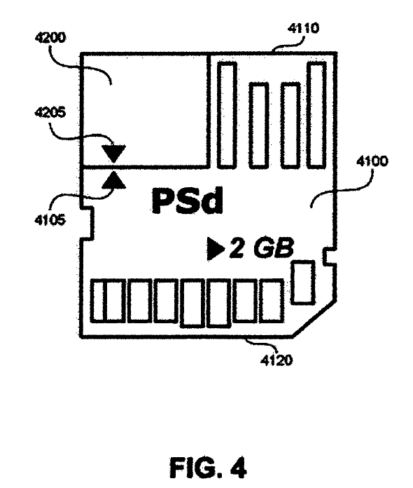

FIG. 4 shows an exemplary non-volatile storage device according to one embodiment of the present invention. This is only one of many available non-volatile storage devices. In this embodiment, the non-volatile storage device is a specially designed Secure Digital (hereinafter SD) Card 4000. The SD Card 4000 comprises a body portion 4100 of the non-volatile memory device having a USB accessible edge 4110 and a SD accessible edge 4120, and a removable portion 4200. When the removable portion 4200 is attached to the body portion 4100 of the non-volatile memory device with two arrows 4105 and 4205 aligned, the non-volatile memory device becomes a SD card accessible from a SD accessible edge 4120. When the removable portion 4200 is not attached to the body portion 4100 of the non-volatile memory device, the non-volatile memory device becomes a SD card accessible from its USB accessible edge 4110. This embodiment presents a portable and flexible way to install software onto a computer, a portable phone or a mobile device.

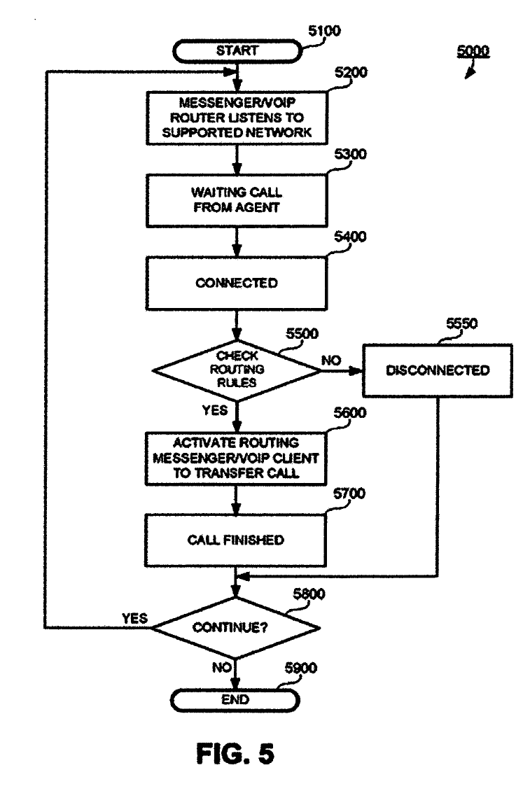

Referring now to FIG. 5, a flow chart 5000 showing the call connection operation of a Messenger/VoIP Router System is shown according to one embodiment of the present invention. When the software is installed in a computer, a portable phone, or a mobile device, the MVRS system starts as shown in step 5100 after a brief automatic configuration process. Then the MVRS listens to all supported networks and client interfaces in step 5200 and waits for call from a user agent in step 5300. If a call from one of user agents through the internal interface or external interface is detected by the MVRS, then this calls is first connected to the MVRS in step 5400. The MVRS checks parameters of the call such as the source and the destination of the call, the protocol of the call, the multimedia level of the call (text, audio, or visual), the caller and callee information etc. as shown in step 5500. The MVRS then check against the contact information to ascertain that both caller and callee are valid users in the contact list, the multimedia levels of the caller matches that of the callee, and the callee is available to receive the call. If the caller or the callee is not a valid user in the contact list, or if the callee is not available for the call, the MVRS disconnects the call in step 5550 and goes to 5800. Otherwise, the MVRS transfers the call according to a set of pre-configured interconnecting rules. If the multimedia levels of the caller and the callee do not match, the MRVS attempts to select a multimedia level that minimally matches both multimedia levels and connects the call as shown in step 5600. If the caller and callee are using different protocols, appropriate message conversion process may be needed to facilitate the call. When the call is completed, or the communication session is ended in step 5700, the MVRS processes to check if a termination instruction is received in step 5800. Such as termination instruction includes the user terminates the operation of the software, or the computer, the portable phone or the mobile device where the software is running is switched off. If the software continues to run, the MVRS returns to step 5200 and listens to its supported network(s). Otherwise the MVRS terminates at step 5900.

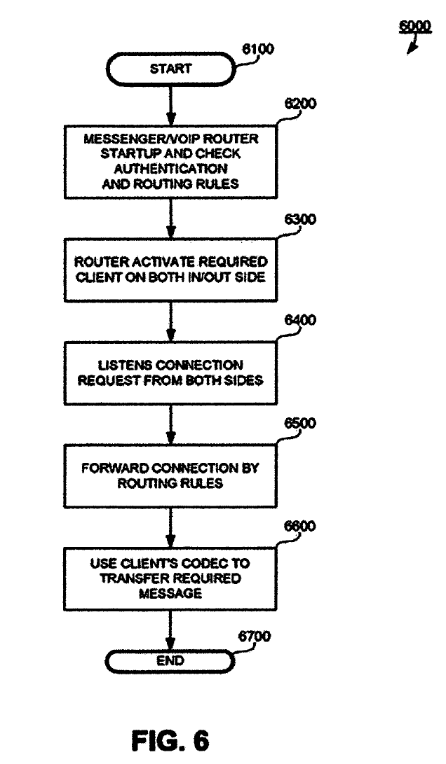

Referring now to FIG.6, a flow chart showing the connection process of a Messenger/VoIP Router System is present according to one embodiment of the present invention. This is the detail operation of the step 5600 in FIG.6. When a valid call comes through at step 6100, the MVRS starts up and checks the authentication and routing rules as shown in step 6200. Then the MVRS activates the appropriate clients of the internal and external interfaces as shown in step 6300. For instance, if an external user uses Skype® protocol to call a user at the internal interface side who is using SIP protocol, then the SIP client of the internal interface and the Skype® client of the external interface are activated. The MVRS monitors the connection request from both the internal and external sides as shown in step 6400. If a call is received from either side, then the call is forwarded to the destination according to the interconnection rules as shown in step 6500. If the communication protocols are different in the internal and external interfaces, the message may require the clients in internal and external interfaces to convert the incoming message to corresponding outgoing message as shown in step 6600. The communication continues until one of the two sides terminates the call as shown in step 6700.

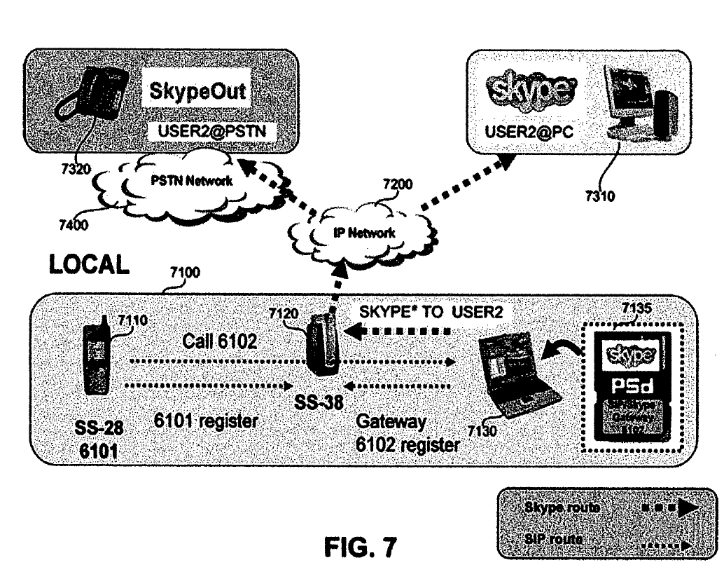

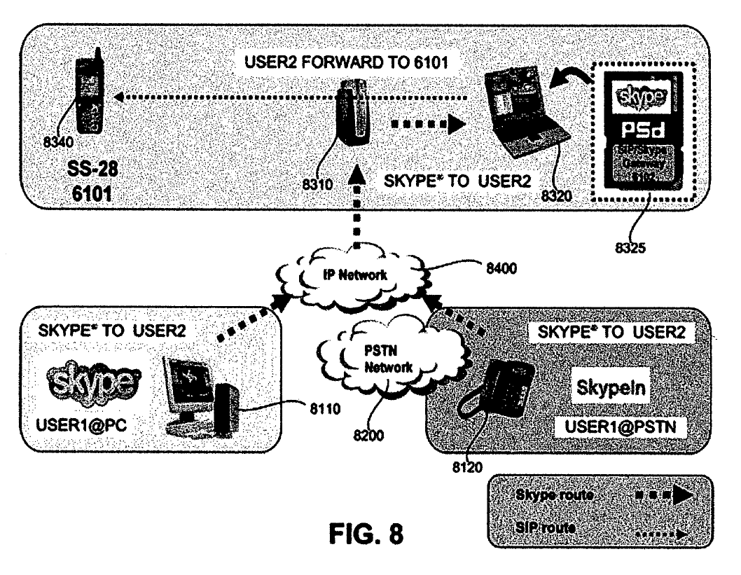

In order to illustrate how the MVRS works, two examples are shown below according to embodiment of the present invention. FIG. 7 illustrates how a SIP call is transferred to a Skype® call and FIG. 8 illustrates how a Skype® call is transferred to a SIP call.

Referring now to FIG. 7, a scenario of a SIP protocol USER1 calling a Skype® protocol USER2 is presented according to one embodiment of the present invention. The local side IP networks 7100 comprises: (a) a SIP protocol portable one (SS-28) 7110, (b) a Gateway Router (SS-38) 7120, and a computer 7120 with the MVRS system 7135 installed and running. Before any call can be made, the computer 7130 and the portable phone 7110 both are registered with the Gateway Router 7120. USER1 using SIP protocol make a call to USER2 using Skype® protocol. According to the contact list, the MVRS determines that the callee USER2 is a Skype® user from the configuration data stored in the personal storage disc 7135. Then the MVRS initiates a Skype® call from the computer 7130 to the Internet 7200 though the Gateway Route 7120. The USER2 may have two different ways to receive a Skype® call. The one is to use a personal computer 7310 to receive a call using USER2@PC as an address. The other is to use the SkypeOut® service to make a Skype® call at a conventional telephone number USER2@PSTN. If the configuration data indicates that the USER2 has two different settings, then the MVRS with attempt to connect with one of two connection methods first. If the first attempt fails, then a second attempt is tried as an alternative. For example, if the USER2 has both Skype® at PC and SkypeOut® number, then MVRS tries the Skype® at PC first. If this approach fails, the MVRS then tries to connect with SkypeOut®. Different orders of trying different approaches are possible and they are configured at the start up.

Referring now to FIG. 8, a scenario of a Skype® protocol USER1 calling a SIP protocol USER2 is presented according to one embodiment of the present invention. The USER1 may have two different ways to make a Skype® call. The one is to use a personal computer 7310 to make a call using USER1 @PC as an address. The other is to use the SkypeIn® service and conventional phone 8120 to make a Skype® call at a conventional telephone number USER1@PSTN. On the receiving side, the USER2 has Gateway Route 8310, a personal computer 8320 with the MVRS software installed and running, and a portable SIP phone 8340. USER1 using Skype® protocol make a call to USER2 using SIP protocol. The call originated either from USER1@PC or USER1@PSTN reaches the Gateway Router 8310 through an IP network 8200. This IP network 8310 comprises a LAN or the Internet. According to the contact list, the MVRS determines that the callee USER2 is a SIP user from the configuration data stored in a personal storage disc 8325. Then the MVRS forwards the Skype® call from the computer 8320 to the SIP phone 8340 and the call from the USER1 to USER2 is established.

SIP phone has evolved from a desktop PC, to a stationary SIP phone, a portable SIP phone. With some of the smart mobile devices equipped with WiFi or other Internet access and installation of the MVRS software, these smart mobile devices become mobile SIP phones.

The present invention also encompasses computer readable medium having computer-executable instructions for performing methods of the present invention, and computer networks and other systems that implement the methods of the present invention.

The above features as well as additional features and aspects of the present invention are disclosed herein and will become apparent from the foregoing description of preferred embodiments of the present invention.

While there has been shown several and alternate embodiments of the present invention, it is to be understood that certain changes can be made as would be known to one skilled in the art without departing from the underlying scope of the present invention as is discussed and set forth above and below including claims. Furthermore, the embodiments described above and claims set forth below are only intended to illustrate the principles of the present invention and are not intended to limit the scope of the present invention to the disclosed elements.

What is claimed is:

1. A system for interconnecting communications in different communication protocols, comprising:
(i) an internal interface having at least one client using at least one of a first group of communication protocols, for communicating with a user;
(ii) an external interface having at least one client using at least one of a second group of communication protocols, for communicating with at least one recipient; and
(iii) a Messenger/VoIP Router System (MVRS) for interconnecting communication between the user and the at least one recipient,
wherein, in operation, the user initiates or receives a communication using at least one of the first group of communication protocols, and the MVRS interconnects the communication to or from the at least one recipient using at least one of the second group of communication protocols according to a set of interconnecting rules maintained in the MVRS.

2. The system of claim 1, wherein the MVRS comprises:
(i) a connection control unit for controlling all call logic and system command function;
(ii) a media stream router for interconnecting, converting and matching media streams of different protocols;
(iii) a message router for interconnecting, converting messages of different protocols; and
(iv) a routing table for determining the messenger message and media stream routing.

3. The system of claim 1, wherein the MVRS comprises:
(i) a connection control unit for controlling all call logic and system command function;
(ii) a message router for interconnecting, converting messages of different protocols; and
(iii) a routing table for determining the messenger message and media stream routing.

4. The system of claim 1, wherein the MVRS comprises:
(i) a connection control unit for controlling all call logic and system command function;
(ii) a media stream router for interconnecting, converting and matching media streams of different protocols; and
(iii) a routing table for determining the messenger message and media stream routing.

5. The system of claim 1, wherein the first group of communication protocols comprise conventional telephone, Voice over IP (VoIP), Session Initiation Protocol (SIP), Media Gateway Control Protocol (MGCP), H.323, Skype®, Gabber®, American On Line® (AOL®), instant messaging computer program (ICQ), Google® Talk, Yahoo® Messenger, MSN® Messenger, and other proprietary and open control messengers protocols.

6. The system of claim 1, wherein the second group of communication protocols comprise conventional telephone, Voice over IP (VoIP), Session Initiation Protocol (SIP), Media Gateway Control Protocol (MGCP), H.323, Skype®, Gabber®, American On Line® (AOL®), instant messaging computer program (ICQ), Google® Talk, Yahoo® Messenger, MSN® Messenger, and other proprietary and open control messengers protocols.

7. The system of claim 1, wherein the communications comprise conventional telephone calls, VoIP calls, video conference calls, instant message sessions, multi-media instant messenger sessions, online games, and virtual realities, among two or more people.

8. The system of claim 1 is software stored in a non-volatile storage device.

9. The system of claim 8, wherein the non-volatile storage device comprises compact flash memory, secure digital memory (SD), mini SD, micro SD, memory stick, memory stick Duo, floppy disk, CD R/W, DVD R/W and other readable and writable, or read-only memory device.

10. The system of claim 8, wherein the non-volatile storage device further stores at least one of contact information, interconnection rules, configuration data, authentication/authorization information and communication log and historical data.

11. The system of claim 10, wherein the authentication/authorization information stored in the non-volatile storage device enables the user communicate with the at least one recipient securely and prevents unauthorized uses.

12. The system of claim 8, wherein the non-volatile storage device is accessible by a computer, a portable phone, or a mobile device.

13. The system of claim 12, wherein the computer, the portable phone, or the mobile device is connected to the Internet.

14. The system of claim 8, wherein the software is accessible through available USB ports, memory card slots, CD/DVD readers, floppy drives of the computer, the portable phone, or the mobile device.

15. A method for interconnecting communications in different communication protocols, comprising the steps of:
(i) installing software on a computer, a portable phone or a mobile device, wherein the software comprises:
(a) an internal interface 1200 having at least one client using at least one of a first group of communication protocol, for communicating with a user;
(b) an external interface 1300 having at least one client using at least one of a second group of communication protocol, for communicating with at least one recipient; and
(c) a Messenger/VoIP Router System (MVRS) for interconnecting communication between the user and the at least one recipient,
(ii) setting up contact information;
(iii) setting up interconnection rules;
(iv) waiting for a incoming communication from supported networks;
(v) routing the incoming communication to destination with the same or different communication protocol according to the interconnection rules stored in the routing table to establish a communication;
(vi) terminating the communication; and
(vii) repeating steps (iv) through step (vi) until the computer, the portable phone, or the mobile device is instructed to terminate or is switched off.

16. The method of claim 15, wherein the first group of communication protocols comprise conventional telephone, voice over IP (VoIP), Session Initiation Protocol (SIP), Media Gateway Control Protocol (MGCP), H.323, Skype®, Gabber®, American On Line® (AOL®), instant messaging computer program (ICQ), Google® Talk, Yahoo® Messenger, MSN® Messenger, and other proprietary messengers and open control protocols.

17. The method of claim 15, wherein the second group of communication protocols comprise conventional telephone, voice over IP (VoIP), Session Initiation Protocol (SIP), Media Gateway Control Protocol (MGCP), H.323, Skype®, Gabber®, American On Line® (AOL®), instant messaging computer program (ICQ), Google®) Talk, Yahoo® Messenger, MSN® Messenger, and other proprietary messengers and open control protocols.

18. The method of claim 15, wherein the communications comprise a conventional telephone call, a VoIP call, a video conference call, a instant message session, a multi-media instant messenger session, among two or more people.

19. The method of claim 15, wherein the computer, the portable phone, or the mobile device is connected to the Internet.

20. The method of claim 15, wherein the MVRS comprises:
(i) a connection control unit for controlling all call logic and system command function;
(ii) a media stream router for interconnecting, converting and matching media streams of different protocols;
(iii) a message router for interconnecting, converting messages of different protocols; and
(iv) a routing table for determining the messenger message and media stream routing.

21. The method of claim 15, wherein the MVRS comprises:
(i) a connection control unit for controlling all call logic and system command function;
(ii) a message router for interconnecting, converting messages of different protocols; and
(iii) a routing table for determining the messenger message and media stream routing.

22. The method of claim 15, wherein the MVRS comprises:
(i) a connection control unit for controlling all call logic and system command function;
(ii) a media stream router for interconnecting, converting and matching media streams of different protocols; and
(iii) a routing table for determining the messenger message and media stream routing.

23. The method of claim 15, wherein the installing software step comprises the step of extracting the software from a non-volatile storage device.

24. The method of claim 23, wherein the non-volatile storage device comprises compact flash memory, secure digital memory (SD), mini SD, micro SD, memory stick, memory stick Duo, floppy disk, CD R/W, DVD R/W and other readable, writable or read-only memory card.

25. The method of claim 23, wherein the non-volatile storage device stores contact information, interconnection rules, configuration data, authentication/authorization information and communication log and historical data.

26. The method of claim 23 wherein the step of setting up contact information comprises the step of extracting contact information from the non-volatile storage device.

27. The method of claim 23, wherein the step of setting up interconnection rules comprises the step of extracting interconnection rules from the non-volatile storage device.

28. A computer-readable medium having computer executable instructions for interconnecting communications in different communication protocols, comprising:
(i) an internal interface having at least one client using at least one of a first group of communication protocol, for communicating with a user;
(ii) an external interface having at least one client using at least one of a second group of communication protocol, for communicating with at least one recipient; and
(iii) a Messenger/VoIP Router System (MVRS) for interconnecting communication between the user and the at least one recipient,
wherein, in operation, the user initiates or receives a communication using at least one of the first group of communication protocols, and the MVRS interconnects the communication to or from the at least one recipient using at least one of the second group of communication protocols according to a set of interconnecting rules maintained in the MVRS.
